(19) United States
(12) Patent Application Publication
(10) Pub. No.: US 2015/0287173 A1
(43) Pub. Date: Oct. 8, 2015

(54) PERIODIC PATTERN HANDLING BY DISPLACEMENT VECTORS COMPARISON

(71) Applicant: Samsung Electronics Co., Ltd., Suwon-si (KR)

(72) Inventor: Dan GLUCK, Ramat Gan (IL)

(73) Assignee: Samsung Electronics Co., Ltd., Suwon-si (KR)

(21) Appl. No.: 14/244,621

(22) Filed: Apr. 3, 2014

(51) Int. Cl. G06T 5/00; G06K 9/52; G06K 9/62; G06T 7/00

(52) U.S. Cl. CPC G06T 5/006; G06T 7/0079; G06K 9/52; G06K 9/6202

(57) ABSTRACT

Provided are a method and an apparatus for correcting an erroneous displacement vector in an image. The apparatus includes: an image divider configured to divide an image into a plurality of segments according to displacement vectors of pixels of the image, each of the plurality of segments corresponding to a representative displacement vector; an erroneous displacement vector detector configured to determine whether a representative displacement vector of a current comparing segment, from among the plurality of segments, is erroneous due to periodicity by comparing the representative displacement vector of the current comparing segment with a representative displacement vector of a reference segment, from among the plurality of segments; and a displacement vector corrector configured to correct the representative displacement vector of the current comparing segment in response to the erroneous displacement vector detector determining that the representative displacement vector of the current comparing segment is erroneous.

### BACKGROUND

1. Field

Methods and apparatuses consistent with exemplary embodiments relate to image processing, and more particularly, to determining erroneous displacement vectors due to a periodic pattern and correcting the determined erroneous displacement vectors.

2. Description of the Related Art

Related art computer display applications and image processing applications may include an operation of determining a correspondence between image patches of two images. For example, this task is common in video compression, motion estimation, three-dimensional (3D) image generating, stereo matching, frame rate conversion, etc. The correspondence can be defined in terms of a displacement vector field (i.e., displacement map) between the two images.

Related art methods of obtaining such a displacement map make use of some measure of similarity between image patches of the respective images. A patch of one image may, however, have several similar counterparts in the other image, and additional information may be used in order to decide which of the several similar counterparts is most appropriate for the application, or is the “true” counterpart. For example, in motion estimation, the desired displacement vector is the one that is closest to the actual motion. This additional information is usually obtained through spatial considerations, with a particular preference for a smooth displacement vector field.

Periodic patterns in the image pose a unique difficulty for such methods, since a patch of one image may be similar to several patches of a periodic pattern in the other image, as illustrated in FIG. 1.

As shown in FIG. 1, a patch 110 as represented by the rectangle in the image 1 may be determined to correspond to either of two different patches 120 and 130 in the image 2. That is, in the image 2, the lower patch 120 is the correct corresponding patch, while the similar patch 130 indicated by the upper arrow is not the corresponding patch. The non-corresponding patch 130 in the image 2 may be identical to the patch 110 in the image 1 due to the periodicity, and therefore may be incorrectly identified as the corresponding patch.

For some applications, including motion estimation, the incorrect correspondence must be detected and corrected. Related art methods for dealing with periodic patterns in this context and others detect the periodic patterns by applying Fourier transform to the images. Such methods apply Fourier transform to image parts in different window sizes, so that a periodic pattern covering an area of an arbitrary size can be detected. However, this method has several drawbacks.

In particular, the related art Fourier transform method has inherent inaccuracies and poor detection abilities. For example, for a window of size K×K that includes n periods of size K/n each, the periodic pattern would appear as a peak in a Fourier domain. The resolution of this domain can separate at best K/n from K/(n+1). Therefore, this application has an inherent inaccuracy of K/n² pixels, and results in poor detection ability for a small number of periods, or for a periodic pattern whose period length is small. Additionally, this method includes intensive computations for calculating a Fourier transform over a wide range of window sizes and locations, which is time and energy consuming.

Another related art method identifies periodic patterns by analyzing the space of all possible displacement vectors per patch and identifying periodic minima in a similarity metric. While this method does not apply Fourier transform to the images, this method uses high consumption of computation power, since an exhaustive search is done for the displacement vectors. Moreover, this method has high memory requirements as well.

### SUMMARY

Aspects of one or more exemplary embodiments provide a method and apparatus for detecting an erroneous displacement vector in an image.

Aspects of one or more exemplary embodiments also provide a method and apparatus for correcting an erroneous displacement vector detected in an image.

According to an aspect of an exemplary embodiment, there is provided an apparatus for correcting an erroneous displacement vector in an image, the apparatus including: an image divider configured to divide an image into a plurality of segments according to displacement vectors of pixels of the image, each of the plurality of segments corresponding to a representative displacement vector; an erroneous displacement vector detector configured to determine whether a representative displacement vector of a current comparing segment, from among the plurality of segments, is erroneous due to periodicity by comparing the representative displacement vector of the current comparing segment with a representative displacement vector of a reference segment, from among the plurality of segments; and a displacement vector corrector configured to correct the representative displacement vector of the current comparing segment in response to the erroneous displacement vector detector determining that the representative displacement vector of the current comparing segment is erroneous.

The image divider may be configured to divide the image into the plurality of segments based on a displacement vector map for the image, the displacement vector map identifying each pixel or group of pixels of the image with a corresponding pixel or group of pixels of a corresponding image shifted by a corresponding displacement vector.

The image divider may be configured to determine, based on the displacement vector map, connected components of pixels which are within a predetermined distance of each other and have same displacement vector values or displacement vector values that are similar to a predetermined degree, and to merge the determined connected components of pixels to form the plurality of segments.

The image divider may be configured to determine and merge the connected components of pixels using a flood fill algorithm.

The image divider may be configured to determine, as a representative displacement vector of a segment from among the plurality of segments, a mean displacement vector of displacement vectors of pixels of the segment.

The erroneous displacement vector detector may be configured to determine, as the reference segment, a largest segment from among the plurality of segments.

The erroneous displacement vector detector may be configured to determine, as the reference segment, a largest segment from among the plurality of segments determined to have a common border with the current comparing segment and a different representative displacement vector than the representative displacement vector of the current comparing segment.

The erroneous displacement vector detector may be configured to compare the representative displacement vector of the current comparing segment with representative displacement vectors of a predetermined number of reference segments, from among the plurality of segments, to determine if the representative displacement vector of the current comparing segment is erroneous due to periodicity.

The erroneous displacement vector detector may be configured to determine that the representative displacement vector of the current comparing segment is erroneous in response to determining that \vec{u}≡\vec{v}ⱼ−\vec{v}ᵢ is a period of the current comparing segment, where \vec{v}ⱼ is the representative displacement vector of the current comparing segment and \vec{v}ᵢ the representative displacement vector of the reference segment.

The erroneous displacement vector detector may be configured to determine that \vec{u}≡\vec{v}ⱼ−\vec{v}ᵢ is the period of the current comparing segment by computing SAD (Cⱼ, \vec{w}) for a group of different vectors \vec{w} which are distributed between a predetermined range of \vec{u}, applying a parabolic approximation using a Savitzky-Golay filter, and comparing a minimum of a corresponding parabola with \vec{u}.

In response to the erroneous displacement vector detector determining that the representative displacement vector of the current comparing segment is erroneous, the displacement vector corrector may be configured to replace the representative displacement vector of the current comparing segment with the representative displacement vector of the reference segment or to shift the representative displacement vector of the current comparing segment by the representative displacement vector of the reference segment.

According to an aspect of another exemplary embodiment, there is provided a method for correcting an erroneous displacement vector in an image, the method including: dividing an image into a plurality of segments according to displacement vectors of pixels of the image, each of the plurality of segments corresponding to a representative displacement vector; determining whether a representative displacement vector of a current comparing segment, from among the plurality of segments, is erroneous due to periodicity by comparing the representative displacement vector of the current comparing segment with a representative displacement vector of a reference segment, from among the plurality of segments; and correcting the representative displacement vector of the current comparing segment in response to determining that the representative displacement vector of the current comparing segment is erroneous.

The dividing the image may include: determining, based on a displacement vector map, connected components of pixels which are within a predetermined distance of each other and have same displacement vector values or displacement vector values that are similar to a predetermined degree; and merging the determined connected components of pixels to form the plurality of segments, wherein the displacement vector map identifies each pixel or group of pixels of the image with a corresponding pixel or group of pixels of a corresponding image shifted by a corresponding displacement vector.

The determining whether the representative displacement vector of the current comparing segment is erroneous due to periodicity may include determining that the representative displacement vector of the current comparing segment is erroneous in response to determining that \vec{u}≡\vec{v}ⱼ−\vec{v}ᵢ is a period of the current comparing segment, where \vec{v}ⱼ is the representative displacement vector of the current comparing segment and \vec{v}ᵢ the representative displacement vector of the reference segment.

The correcting the representative displacement vector of the current comparing segment may include, in response to determining that the representative displacement vector of the current comparing segment is erroneous, replacing the representative displacement vector of the current comparing segment with the representative displacement vector of the reference segment or shifting the representative displacement vector of the current comparing segment by the representative displacement vector of the reference segment.

According to an aspect of another exemplary embodiment, there is provided a non-transitory computer readable recording medium having recorded thereon a program executable by a computer for performing the above-described method.

According to an aspect of another exemplary embodiment, there is provided a method of detecting an erroneous representative displacement vector from among a plurality of representative displacement vectors respectively corresponding to a plurality of segments, the method including: comparing a representative displacement vector of a current comparing segment, from among the plurality of segments, with a representative displacement vector of a reference segment, from among the plurality of segments; and determining, based on the comparing, whether the representative displacement vector of the current comparing segment is erroneous due to periodicity, wherein the comparing and the determining are performed, for the current comparing segment, repeatedly with different reference segments, from among the plurality of segments, until the representative displacement vector of the current comparing segment is determined to be erroneous or until the representative displacement vector of the current comparing segment has been compared to representative displacement vectors of a predetermined number of different segments.

The determining may include determining that the representative displacement vector of the current comparing segment is erroneous in response to determining that \vec{u}≡\vec{v}ⱼ−\vec{v}ᵢ is a period of the current comparing segment, where \vec{v}ⱼ is the representative displacement vector of the current comparing segment and \vec{v}ᵢ is the representative displacement vector of the reference segment.

The comparing may include determining, as the reference segment, a segment determined to have a common border with the current comparing segment and a different representative displacement vector than the representative displacement vector of the current comparing segment.

According to an aspect of another exemplary embodiment, there is provided a non-transitory computer readable recording medium having recorded thereon a program executable by a computer for performing the above-described method.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates patch correspondence ambiguity due to periodic patterns in an image;

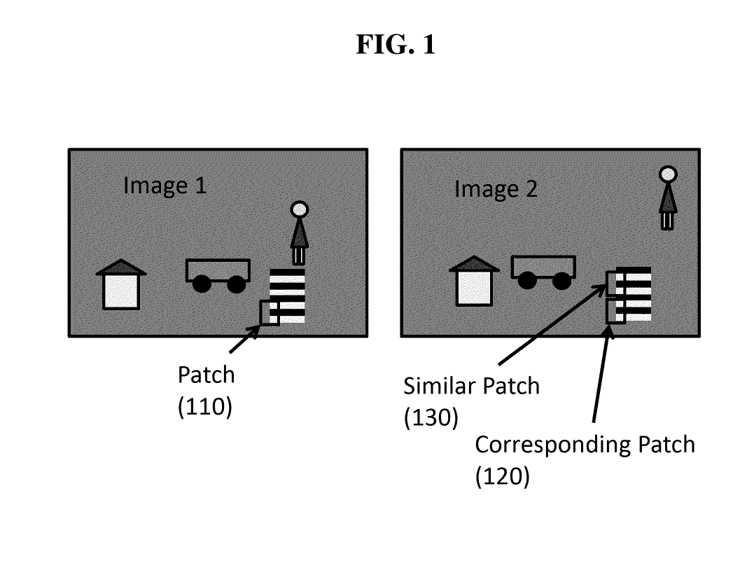

FIG. 2 illustrates an apparatus for correcting an erroneous displacement due to a periodic pattern in an image, according to an exemplary embodiment;

FIGS. 3A to 3C illustrate an example of correcting a displacement vector for an image divided into a plurality of segments, according to an exemplary embodiment;

FIG. 4 is a flowchart of a method of correcting an erroneous displacement vector due to a periodic pattern in an image, according to an exemplary embodiment;

FIG. 5 is a flowchart of a method of dividing an image into a plurality of segments according to displacement vectors of pixels of the image, according to an exemplary embodiment;

FIG. 6 is a flowchart of a method of detecting an erroneous displacement vector due to a periodic pattern in an image, according to an exemplary embodiment; and

FIGS. 7A to 7D illustrate an exemplary result of displacement vector correction according to an exemplary embodiment.

The patent or application file contains at least one drawing executed in color. Copies of this patent or patent application publication with color drawing(s) will be provided by the Office upon request and payment of the necessary fee.

### DETAILED DESCRIPTION OF EXEMPLARY EMBODIMENTS

Exemplary embodiments will now be described in detail with reference to accompanying drawings so as to be easily realized by a person having ordinary skill in the art. The inventive concept may be embodied in various forms without being limited to exemplary embodiments set forth herein. Descriptions of well-known parts are not shown in detail to avoid unnecessarily obscuring exemplary embodiments, and like reference numerals refer to like elements throughout. Hereinafter, it is understood that expressions such as “at least one of,” when preceding a list of elements, modify the entire list of elements and do not modify the individual elements of the list.

According to one or more exemplary embodiments, efficient periodic pattern handling in an image in terms of time and accuracy may be achieved in identifying and correcting displacement vector errors in the image due to periodic patterns by considering relations between displacement vectors of segments of the image in order to identify suspected periodicities in the image which could have resulted in an erroneous displacement vector. By relying on the displacement vectors, no assumption can be taken as to how the displacement field has been produced (e.g., no exhaustive search is implemented), nor are there substantial memory requirements as compared to related art methods.

In further detail, a relatively small number of possible error-generating periodicities may be identified according to one or more exemplary embodiments. This allows checking specifically if these periodicities exist in the original image, thus avoiding the drawbacks of using Fourier transform. Accordingly, efficiency in terms of time and space is achieved. Also, high sensitivity to periodic patterns that have a small number of periods, for example, as low as two to three periods, or of small period length, for example, as low as a few pixels, is achieved.

In one or more exemplary embodiments, if an incorrect displacement vector exists due to a periodic pattern in the image, \vec{w}−\vec{v} (where \vec{w} is the incorrect displacement vector of a segment of the image and \vec{v} is the correct displacement vector) may correspond to a period of the periodic pattern, i.e., a shift under which the periodic pattern is self-similar.

Furthermore, a method of identifying an incorrect displacement vector in an image according to an exemplary embodiment may assume that a smaller segment of the image having a wrong displacement vector due to a periodic pattern is adjacent to a larger segment of the image having the correct displacement vector. This larger, correct segment may be a part of the same object which also includes a periodic pattern, or include one or more other objects that have the same true shift (e.g., the same true motion vector). For example, the larger, correct segment may be from another part of the image with the same motion as the incorrect periodic segment.

Although it may be common that a smaller segment having a wrong displacement vector due to a periodic pattern is adjacent to a larger segment having the correct displacement vector, it is also possible that the opposite is the case, i.e., a larger segment having the wrong displacement vector is adjacent to a smaller segment having the correct displacement vector. Thus, a method of identifying an incorrect displacement vector according to one or more other exemplary embodiments may instead or additionally assume that a larger segment having a wrong displacement vector due to a periodic pattern is adjacent to a smaller segment having the correct displacement vector. This smaller, correct segment may be a part of the same object which also includes a periodic pattern, or include one or more other objects that have the same true shift (e.g., the same true motion vector). For example, the smaller, correct segment may be from another part of the image with the same motion as the incorrect periodic segment.

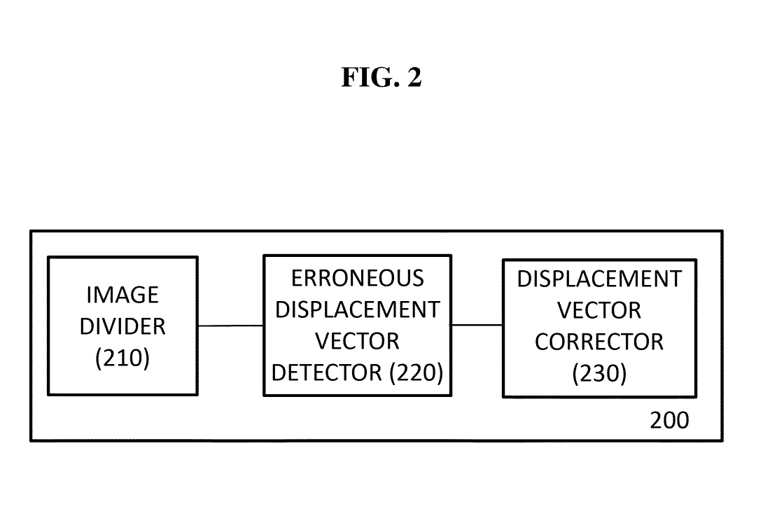

FIG. 2 illustrates an apparatus 200 for correcting an erroneous displacement vector due to a periodic pattern in an image, according to an exemplary embodiment. Referring to FIG. 2, the apparatus 200 for correcting an erroneous displacement vector includes an image divider 210, an erroneous displacement vector detector 220, and a displacement vector corrector 230. The apparatus 200 may be implemented by a computing device, a personal computer, a laptop computer, a workstation, an image processing device, a mobile device, a tablet device, a display device, a receiving device, an image capturing device, etc.

The image divider 210 divides an image (e.g., a received image or a captured image) into a plurality of segments according to displacement vectors of pixels of the image, each of the plurality of segments having a representative displacement vector. In particular, the image divider 210 divides the image such that each of the segments includes a plurality of pixels with the same displacement vectors or similar displacement vectors (e.g., within a predetermined range), which correspond to the representative displacement vector. A displacement vector of a pixel is a vector that indicates a location of a corresponding pixel in another image (e.g., a next image frame, an other-eye corresponding image frame, a reference frame, etc.) By way of example, the image divider 210 may determine the representative displacement vector of a segment as a mean displacement vector of the displacement vectors of some or all of the pixels of the segment. However, it is understood that one or more other exemplary embodiments are not limited thereto. For example, according to other exemplary embodiments, the representative displacement vector may be a median displacement vector of the displacement vectors of some or all of the pixels of the segment, may be the displacement vector of a particular pixel of the segment, etc.

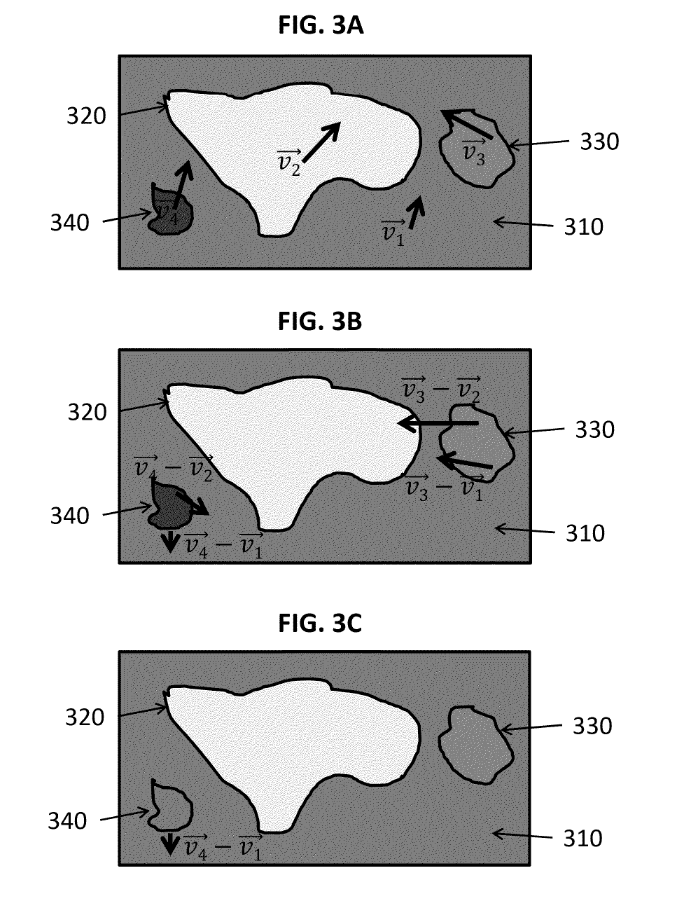

FIG. 3A illustrates an example of dividing an image into a plurality of segments 310, 320, 330, and 340, according to an exemplary embodiment, which may be implemented by the image divider 210 of FIG. 2. Referring to FIG. 3A, the image is divided into the plurality of segments 310, 320, 330, and 340, each segment 310, 320, 330, and 340 including a plurality of spatially adjacent pixels that have the same or similar displacement vectors \vec{V}. That is, the image divider 210 clusters the pixels according to their locations and their displacement vectors \vec{V}.

For example, the image divider 210 may cluster the pixels into the plurality of segments 310, 320, 330, and 340 using a displacement vector map that identifies each pixel or block of an image with a corresponding pixel or block in another image, shifted by the appropriate vector. In this case, the displacement vector map may be generated based on a property that a displacement field is generally smooth except for sharp discontinuities along a few edges. Accordingly, the image divider 210 may divide an image spatially into segments based on a displacement vector map, with the pixels in each segment having an approximately uniform displacement vector.

In further detail, a displacement vector map (e.g., motion vector field) in which a displacement vector is denoted by \vec{V}, and a displacement vector at a pixel \vec{p} is denoted by \vec{V}(\vec{p}), the pixel can be identified at the next or corresponding image (such as an other-eye image of a stereoscopic image) by \vec{p}+\vec{V}(\vec{p}). Thus, in the example illustrated in FIG. 3A, \vec{v}₁, \vec{v}₂, \vec{v}₃, and \vec{v}₄ are the representative displacement vectors pointing from the first segment 310, the second segment 320, the third segment 330, and the fourth segment 340, respectively, in the image to their corresponding segments in a next image, e.g., a corresponding image.

Furthermore, according to an exemplary embodiment, in order to account for both pixel proximity and the values of their displacement vectors, each segment may include connected components of pixels with the same displacement vector values or with similar displacement vector values up to a threshold value. The threshold value may be predetermined, automatically set, or set by a user according to a desired resolution of the corrected image. The connected components which are close both spatially and in their displacement vector values may be merged by the image divider 210 to form a segment, which has a representative displacement vector determined by the image divider 210 as described above.

The image divider 210 may utilize a flood fill algorithm to find connected components of the pixels according to their displacement vectors. Accordingly, each pair of connected components are clustered into a segment if they are determined by the image divider 210 to be both spatially close enough (e.g., within a predetermined spatial range) and to have the same displacement vectors or similar displacement vectors up to a threshold value. The clustered pixels form a segment which has a representative displacement vector.

Referring back to FIG. 2, the erroneous displacement vector detector 220 detects one or more erroneous displacement vectors, from among the representative displacement vectors, by comparing the representative displacement vectors of the plurality of segments with each other. For example, the erroneous displacement vector determiner 220 may check the representative displacement vectors of a first predetermined number of segments (hereinafter “comparing segments”) for error due to periodic patterns in the image by comparing each with the representative displacement vectors of a second predetermined number of segments (hereinafter “reference segments”). In this case, a displacement vector of a particular comparing segment may be determined as erroneous if the difference between the displacement vector of the comparing segment and a displacement vector of a particular reference segment is a period of the comparing segment.

According to one or more exemplary embodiments, the comparing segments may be manually selected by a user, may be all of the segments of the image, may be randomly set or determined, or may be set or determined according to a predetermined rule (e.g., a predetermined number or ratio of segments that are the smallest segments among the segments of the image, a predetermined number of segments that are the smallest segments of at least a predetermined size, a predetermined number of segments that are the largest segments from among the segments of the image, remaining segments that are not among a predetermined number of largest segments, remaining segments that are not among a predetermined number of smallest segments, remaining segments that are not among the reference segments, etc.) Similarly, the reference segments may be manually selected by a user, may be all of the segments of the image, may be randomly set or determined, or may be set or determined according to a predetermined rule (e.g., a predetermined number or ratio of segments that are the smallest segments among the segments of the image, a predetermined number of segments that are the smallest segments of at least a predetermined size, a predetermined number of segments that are the largest segments from among the segments of the image, remaining segments that are not among a predetermined number of largest segments, remaining segments that are not among a predetermined number of smallest segments, remaining segments that are not among the comparing segments, etc.)

FIG. 3B illustrates an example of comparing representative displacement vectors of segments in an image, according to an exemplary embodiment, which may be implemented by the erroneous displacement vector detector 220 of FIG. 2. Referring to FIG. 3B, the first segment 310 and the second segment 320 are the reference segments i, and the third segment 330 and the fourth segment 340 are the comparing segments j which are checked for erroneous displacement vectors. In the exemplary embodiment illustrated in FIG. 3B, for each of the comparing segments j 330 and 340, whether the representative displacement vector \vec{v}ⱼ thereof is an incorrect displacement vector due to a periodic pattern and whether the correct displacement vector is the representative displacement vector \vec{v}ᵢ of one of the reference segments i 310 and 320 is determined for each of the reference segments i 210 and 220 by checking whether the image is periodic under (\vec{v}ⱼ−\vec{v}ᵢ). Accordingly, errors in the displacement map (e.g., failure of motion estimation) due to periodic patterns are detected by comparing the representative displacement vectors of different segments of pixels.

While the above-described exemplary embodiment compares the representative displacement vectors of the comparing segments with the representative displacement vectors of each of the reference segments, it is understood that one or more other exemplary embodiments are not limited thereto. For example, according to another exemplary embodiment, the representative displacement vector of a comparing segment may be compared against the representative displacement vectors of the reference segments one-by-one (e.g., from the largest reference segment to the smallest reference segment) until (\vec{v}ⱼ−\vec{v}ᵢ) is determined to be a period of the comparing segment (e.g., if the representative displacement vector is determined to be erroneous after a first comparison against a first reference segment, the comparison may end for the current comparing segment or for all comparing segments without subsequently being made against the remaining reference segments). Furthermore, according to one or more other exemplary embodiments, the conditions for comparing may include at least one of: (1) the comparing segment j for which the incorrect displacement vector is checked is smaller (e.g., includes less pixels) than the reference segment i being compared; (2) the comparing segment j and the reference segment i being compared have different representative displacement vectors; and (3) the comparing segment j and the reference segment i being compared have a common border, i.e., the reference segment i has one or more pixels which are adjacent to one or more pixels of the comparing segment j. It is understood that other exemplary embodiments are not limited to the above-described conditions, and may include additional conditions, one or more of the above-described conditions (e.g., the first and second conditions but not the third condition, as shown in the exemplary embodiment of FIG. 3B), or none of the above-described conditions.

Furthermore, with respect to the third condition, it may be further conditioned according to an exemplary embodiment that the length of the common border is of at least a predetermined size, e.g., at least a predetermined number of pixels of one or both of the reference segment i and the comparing segment j, at least a predetermined ratio (such as half) of the perimeter of one or both of the reference segment i and the comparing segment j, etc. Moreover, according to an exemplary embodiment, the erroneous displacement vector detector 220 may determine the common border may by creating or using a connectivity matrix of the segments, which assigns for each pair of segments the number of connections therebetween. That is, a connection between two segments is a pair of pixels with one pixel in one segment and another pixel in the other segment. Thus, if the segments are represented by {Cᵢ}, then the connectivity matrix M may be defined as:

Mᵢⱼ=card({(p,q)|pεCᵢ [symbol] qεCⱼ [symbol] Adj(p,q)}),

where Adj(p,q) represents that the pixels p and q are adjacent, and card represents the cardinality (i.e., size) of the set. Accordingly, the common border condition for segments Cᵢ and Cⱼ with card(Cᵢ)>card(Cᵢ) may be equivalent to the inequality:

$${M}_{ij} > α {\sum }_{k \neq i , j}^{ } {M}_{kj} ,$$

where α=0.5 in the present exemplary embodiment.

In the present exemplary embodiment, detection of erroneous representative displacement vectors due to periodic patterns may be performed for each pair of segments separately, with a smaller segment being examined against the representative displacement vector of a larger segment. That is, as described above, each of two segments Cᵢ and Cⱼ, with Cᵢ being a larger reference segment and Cⱼ being a smaller comparing segment, may have representative displacement vectors vᵢ and vⱼ, respectively, that are compared with each other. Accordingly, whether part of the image defined by the pixels of Cⱼ is periodic under \vec{u}≡\vec{v}ⱼ−\vec{v}ᵢ is determined.

According to another exemplary embodiment, only a part of Cⱼ, which under translation by \vec{u} is mapped either to Cⱼ itself or to Cᵢ, may be checked for error by the erroneous displacement vector detector 220. This part may be referred to as the relevant part of Cⱼ for convenience of description. The remaining part of Cⱼ may not participate in the periodicity check because even if both Cⱼ and Cᵢ are a part of the same periodic object, the non-relevant part may be too close to a border of this object, and may not be mapped to a similar area under a shift of one cycle.

Furthermore, according to another exemplary embodiment, the erroneous displacement vector detector 220 may filter out one or more segments in the periodicity check of Cⱼ. For example, in an exemplary filtering operation, the sum of absolute difference (SAD) of Cⱼ under translation by \vec{u} (where \vec{u}≡\vec{v}ⱼ−\vec{v}ᵢ), denoted as SAD(Cⱼ, \vec{u}), is compared with the SAD of Cⱼ under translations by 0.5·\vec{u} and 1.5·\vec{u}, which are denoted as SAD(Cⱼ, 0.5·\vec{u}) and SAD(Cⱼ, 1.5·\vec{u}), respectively. In other words, the quantity of SAD(Cⱼ, \vec{u}) is compared with SAD(Cⱼ, 0.5·\vec{u}) and SAD(Cⱼ, 1.5·\vec{u}) with SAD(Cⱼ, \vec{w}) defined according to:

$$SAD ( {C}_{j} , \vec{w} ) = {\sum }_{\vec{i} ∈ Rel ( {C}_{j} )} {\sum }_{c} \vert {I}_{c} ( \vec{i} + \vec{w} ) - {I}_{c} ( i ) \vert$$

Furthermore, it may be determined whether the following two conditions are met in the exemplary filtering operation:

SAD(Cⱼ,\vec{u})<c·SAD(Cⱼ,0.5·\vec{u})

SAD(Cⱼ,\vec{u})<c·SAD(Cⱼ,1.5·\vec{u})

In the above equations, c may be less than 1 to ensure that not every connected component would satisfy the conditions, as would have happened when c is equal to 1. That is, by adjusting the parameter c, the amount of filtering can be controlled.

If at least one of the SAD(Cⱼ, \vec{u})<c·SAD(Cⱼ, 0.5·\vec{u}) and SAD(Cⱼ, \vec{u})<c·SAD(Cⱼ, 1.5·\vec{u}) conditions is not satisfied, then the segment Cⱼ is filtered out from further periodicity checking in the present exemplary embodiment. However, if both conditions are met, then a periodicity checking is performed by the erroneous displacement vector detector 220.

As described above, a representative displacement vector of a segment Cⱼ is determined to be erroneous if periodic under \vec{u}≡\vec{v}ⱼ−\vec{v}ᵢ. The periodicity checking by the erroneous displacement vector detector 220 according to an exemplary embodiment may compute SAD(Cⱼ, \vec{w}) for a predetermined group (e.g., ten) of different vectors \vec{w}, which are distributed between a predetermined range of (e.g., evenly distributed between 0.5·\vec{u} and 1.5·\vec{u}). Then, a parabolic approximation may be obtained by a Savitzky-Golay filter and the minimum of the parabola is compared with \vec{u}. If the difference between the minimum of the parabola and \vec{u} is less than a predetermined threshold, a periodic pattern in the segment Cⱼ with period of \vec{u} is determined by the erroneous displacement vector detector 220.

While the Savitzky-Golay method is utilized in the present exemplary embodiment, it is understood that one or more other exemplary embodiments are not limited thereto, and a minimum of SAD(Cⱼ, \vec{w}) can be determined by utilizing any of other approximation methods. Also, the group of different vectors can be any number of vectors in exemplary embodiments. Further, the group of different vectors can be any of vectors between a predetermined range of \vec{u} (e.g., 0.5·\vec{u} and 1.5·\vec{u}), and is not limited to evenly distributed vectors between 0.5·\vec{u} is and 1.5·\vec{u}. Additionally, the SAD can be replaced by another approach, such as Mean Absolute Difference, Mean Square Error, etc.

Referring back to FIG. 2, the displacement vector corrector 230 corrects the detected one or more erroneous representative displacement vectors. For example, an erroneous representative displacement vector \vec{v}ⱼ of a particular comparing segment j that is found periodic, by the erroneous displacement vector detector 220, by comparing with a representative displacement vector \vec{v}ᵢ of a particular reference segment i may be replaced, by the displacement vector corrector 230, by the representative displacement vector \vec{v}ᵢ or may be shifted, by the displacement vector corrector 230, by the representative displacement vector \vec{v}ᵢ. For example, if it is determined that the segment Cⱼ is periodic with a period of \vec{u} (where \vec{u}≡\vec{v}ⱼ−\vec{v}ᵢ), the displacement vector corrector 230 may correct the displacement vector \vec{v}ⱼ of the segment Cⱼ by replacing the displacement vector \vec{v}ⱼ with \vec{v}ᵢ. Alternatively, the displacement vector corrector 230 may correct the displacement vector \vec{v}ⱼ of the segment Cⱼ by shifting the displacement vector \vec{v}ⱼ by amount of −\vec{u}. After the correction, the segment Cⱼ can be merged with the segment Cᵢ since the two segments have the same displacement vectors or similar displacement vectors.

FIG. 3C illustrates an example of correcting an erroneous representative displacement vector of a segment in an image, according to an exemplary embodiment, which may be implemented by the displacement vector corrector 230 of FIG. 2. Referring to FIG. 3C, if the fourth segment 340, among the comparing segments j 330 and 340, is found periodic under (\vec{v}ⱼ−\vec{v}ᵢ) for the first segment 310, among the reference segments i 310 and 320, the representative displacement vector \vec{v}ⱼ of the fourth segment 340 is shifted by (\vec{v}ⱼ−\vec{v}ᵢ), so that the representative displacement vector of the fourth segment 340 becomes \vec{v}ᵢ or approximately \vec{v}ᵢ. Alternatively, the representative displacement vector of the fourth segment 340 is replaced by \vec{v}ᵢ. Accordingly, the fourth segment 340 is merged with the first segment i 310.

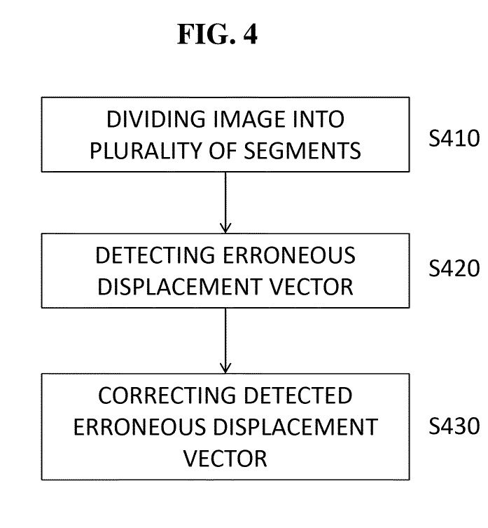

FIG. 4 is a flowchart of a method of correcting an erroneous displacement vector due to a periodic pattern in an image, according to an exemplary embodiment. The method of FIG. 4 may, for example, be implemented by the apparatus 200 for correcting an erroneous displacement vector illustrated in FIG. 2. Referring to FIG. 4, in operation S410, an image is divided into a plurality of segments according to displacement vectors of pixels of the image, each of the plurality of segments having a representative displacement vector. In particular, the image is divided such that each of the segments includes a plurality of pixels with the same displacement vectors or similar displacement vectors (e.g., within a predetermined range), which corresponds to the representative displacement vector. As described above, the representative displacement vector may be a mean displacement vector of the displacement vectors of some or all of the pixels of the segment. However, it is understood that one or more other exemplary embodiments are not limited thereto. For example, according to other exemplary embodiments, the representative displacement vector may be a median displacement vector of the displacement vectors of some or all of the pixels of the segment, may be the displacement vector of a particular pixel of the segment, etc.

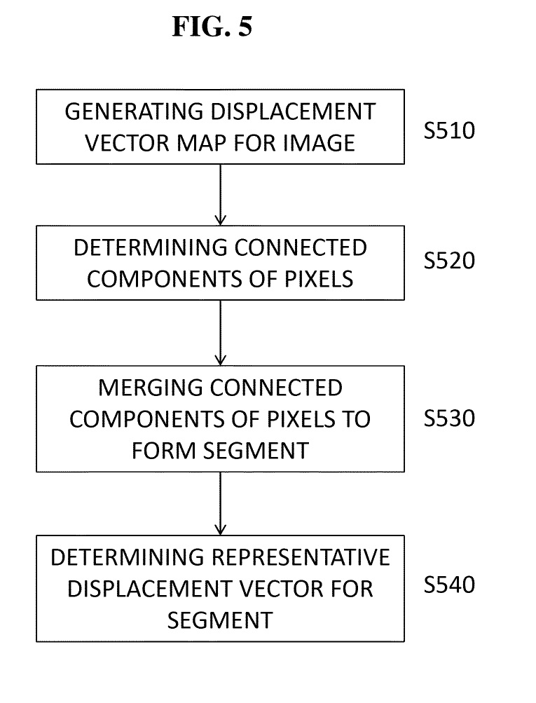

FIG. 5 is a flowchart of a method of dividing an image into a plurality of segments according to displacement vectors of pixels of the image, according to an exemplary embodiment. For example, the method of FIG. 5 may correspond to the dividing operation S410 described above with reference to FIG. 4 and may be implemented by the image divider 210 illustrated in FIG. 2.

Referring to FIG. 5, in operation S510, a displacement vector map is generated for an image with reference to a corresponding image (e.g., next image, other-eye image, etc.) The displacement vector map identifies each pixel, group of pixels, or block of an image with a corresponding pixel, group of pixels, or block of the corresponding image, shifted by the appropriate vector (i.e., displacement vector).

In operation S520, connected components of pixels which are close both spatially (e.g., within a predetermined distance) and in their displacement vector values are determined. Specifically, connected components of pixels may be determined to have the same displacement vector values, or similar displacement vector values up to a predetermined threshold. Furthermore, a flood fill algorithm may be utilized to determine the connected components of pixels.

In operation S530, the determined connected components of pixels are merged to form segments. In operation S540, representative displacement vectors are determined for the segments. For example, the representative displacement vector or a particular segment may be determined as a mean displacement vector of the displacement vectors of some or all of the pixels of the segment, a median displacement vector of the displacement vectors of some or all of the pixels of the segment, the displacement vector of a particular pixel of the segment, etc.

Referring back to FIG. 4, in operation S420, one or more erroneous displacement vectors, from among the representative displacement vectors, are detected by comparing the representative displacement vectors of the plurality of segments with each other. For example, the representative displacement vectors of a first predetermined number of comparing segments may be checked for error due to periodic patterns in the image by comparing with the representative displacement vectors of a second predetermined number of reference segments. In this case, a displacement vector of a particular comparing segment may be determined as erroneous if the difference between the displacement vector of the comparing segment and a displacement vector of a particular reference segment is a period of the comparing segment.

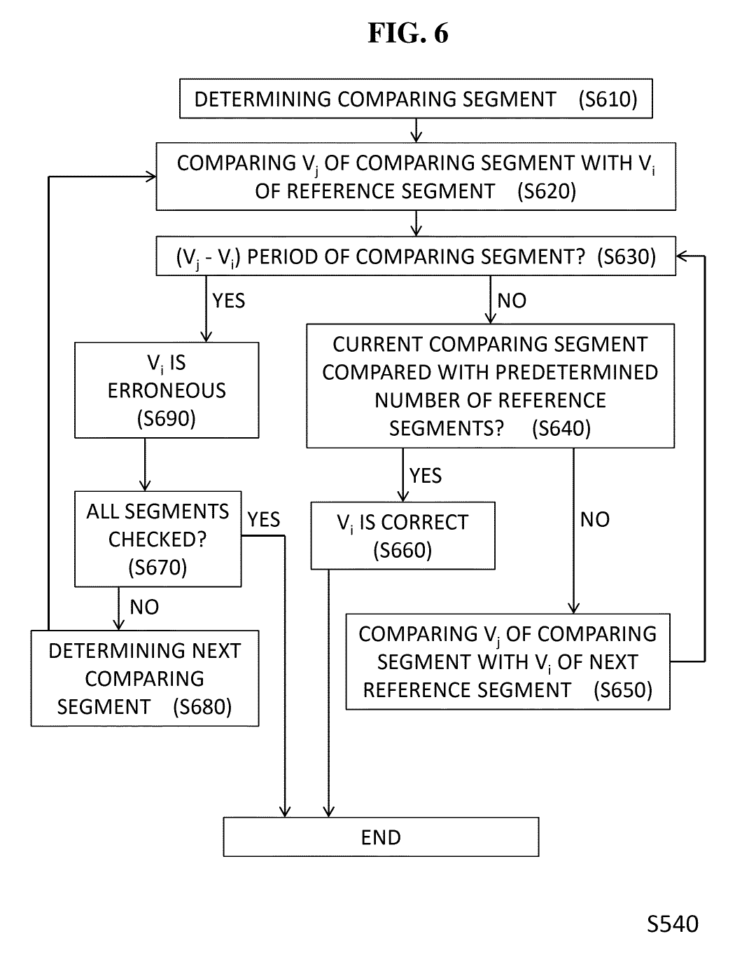

FIG. 6 is a flowchart of a method of detecting an erroneous displacement vector due to a periodic pattern in an image, according to an exemplary embodiment. The method of FIG. 6 may, for example, correspond to the detecting operation S420 described above with reference to FIG. 4 and may be implemented by the erroneous displacement vector 220 illustrated in FIG. 2. Referring to FIG. 6, in operation S610, a comparing segment Cⱼ is determined from among a plurality of segments of an image, each of the segments including a plurality of pixels with the same displacement vectors or similar displacement vectors and each of the segments having a representative displacement vector. In the present exemplary embodiment, the smallest segment from among the segments of the image may be determined as the comparing segment Cⱼ in operation S610. However, it is understood that other exemplary embodiments are not limited thereto. For example, according to other exemplary embodiments, the comparing segment Cⱼ may be determined as the largest segment, may be randomly selected, may be selected by a user, may be determined based on location (e.g., top left segment), may be determined based on a predetermined rule (e.g., highest average luminance), etc.

In operation S620, the representative displacement vector vᵢ of the comparing segment Cⱼ determined in operation S610 is compared with the representative displacement vector vᵢ of a reference segment Cᵢ to obtain \vec{u}, where \vec{u}≡\vec{v}ⱼ−\vec{v}ᵢ. In the present exemplary embodiment, the reference segment Cᵢ is the largest segment among the segments of the image. However, it is understood that other exemplary embodiments are not limited thereto. For example, according to other exemplary embodiments, the initially selected reference segment Cᵢ may be determined as the largest segment having a common border with the current comparing segment Cⱼ, the largest segment having a common border of at least a predetermined size with the current comparing segment Cⱼ, the smallest segment among segments of the image, a segment selected by a user, a randomly determined segment, etc. Furthermore, the initially selected reference segment Cᵢ may be determined as a segment having a representative displacement vector that is different from the representative displacement vector vⱼ of the current comparing segment Cᵢ.

In operation S630, it is determined whether (\vec{u}≡\vec{v}ⱼ−\vec{v}ᵢ) is a period of Cⱼ. The periodicity determination may be performed by computing SAD(Cⱼ, \vec{w}) for a group of different vectors \vec{w}, which are distributed between 0.5·\vec{u} and 1.5·\vec{u} and then applying a parabolic approximation using the Savitzky-Golay method and comparing the minimum of the parabola with \vec{u}. If the difference between the minimum of the parabola and \vec{u} is less than a predetermined threshold, then it may be determined that there is a periodic pattern in the current comparing segment Cⱼ with a period of \vec{u}.

While the present exemplary embodiment performs the periodicity check for every \vec{u} determined in operation S620, it is understood that one or more other exemplary embodiments are not limited thereto. For example, according to another exemplary operation, a filtering operation may be included in order to filter out segments that are not to be further checked for periodicity. For example, in an exemplary filtering operation, the sum of absolute difference (SAD) of Cⱼ under translation by \vec{u} is compared with the SAD of Cⱼ under translations by 0.5·\vec{u} and 1.5·\vec{u} to determine whether a periodicity check (operation S630) is to be performed, as described above.

If a periodic pattern is determined in a current comparing segment Cⱼ (“Yes” in operation S630), the representative displacement vector \vec{v}ⱼ of the segment Cⱼ is determined to be erroneous in operation S690.

If no periodic pattern is determined in the current comparing segment Cⱼ with reference to the representative displacement vector \vec{v}ᵢ of the current reference segment Cᵢ (“No” in operation S630), it is determined whether the current comparing segment Cⱼ has been compared with a predetermined number of reference segments in operation S640. For example, the predetermined number of reference segments may be a pre-set number (e.g., five), may be all of the segments bordering the current comparing segment Cⱼ, may be all of the segments having a common border of at least a predetermined size with the current comparing segment Cⱼ, may be all of the segments that are larger than the current comparing segment Cⱼ, etc.

If the current comparing segment Cⱼ has not been compared with a predetermined number of reference segments (“No” in operation S640), the representative displacement vector vⱼ of the current comparing segment Cⱼ is compared with the representative displacement vector vᵢ of a next reference segment Cᵢ (i.e., different from the previously compared reference segment) to obtain a new \vec{u}, where \vec{u}≡\vec{v}ⱼ−\vec{v}ᵢ, in operation S650. Based on the new operation S630 and subsequent operations are performed. In the present exemplary embodiment, the next reference segment Cᵢ is determined in operation S650 as the next largest segment among the segments of the image. However, it is understood that other exemplary embodiments are not limited thereto. For example, according to other exemplary embodiments, the next reference segment Cᵢ may be determined as the next largest segment having a common border with the current comparing segment Cᵢ, the next largest segment having a common border of at least a predetermined size with the current comparing segment Cⱼ, the next smallest segment among segments of the image, a segment selected by a user, a randomly determined segment, etc. Furthermore, the next reference segment Cᵢ may be determined as a segment having a representative displacement vector that is different from the representative displacement vector vⱼ of the current comparing segment Cⱼ.

Meanwhile, if the current comparing segment Cⱼ has been compared with a predetermined number of reference segments (“Yes” in operation S640), the representative displacement vector \vec{v}ⱼ of the segment Cⱼ is determined to be correct in operation S660. In this case, it is also determined whether the representative displacement vectors of all segments have been checked for error in operation S670. If all the segments have been checked (“Yes” in operation S670), the method ends. While the present exemplary embodiment checks all segments for error, it is understood that other exemplary embodiments are not limited thereto. For example, according to other exemplary embodiments, the periodicity check may be performed for a predetermined number of segments, a predetermined ratio of the total number of segments in the image, etc. Furthermore, according to another exemplary embodiment, the method may end once the representative displacement vector of the current comparing segment Cⱼ is determined to be erroneous, without checking any more segments.

If all segments have not yet been checked (“No” in operation S670), a next comparing segment Cⱼ is determined in operation S680. In the present exemplary embodiment, a next smallest segment (as compared to the current comparing segment) may be determined as the next comparing segment. However, it is understood that other exemplary embodiments are not limited thereto. For example, according to other exemplary embodiments, the next comparing segment Cⱼ may be determined as the next largest segment, may be randomly selected, may be selected by a user, may be determined based on location, may be determined based on a predetermined rule (e.g., next highest average luminance), etc. Based on the next comparing segment Cⱼ, operation S620 and subsequent operations are performed.

Referring back to FIG. 4, in operation S430, the detected one or more erroneous representative displacement vectors are corrected. For example, an erroneous representative displacement vector \vec{v}ⱼ of a particular comparing segment j that is found periodic by comparing with a representative displacement vector \vec{v}ᵢ of a particular reference segment i may be replaced by the representative displacement vector \vec{v}ᵢ or may be shifted by the representative displacement vector \vec{v}ᵢ.

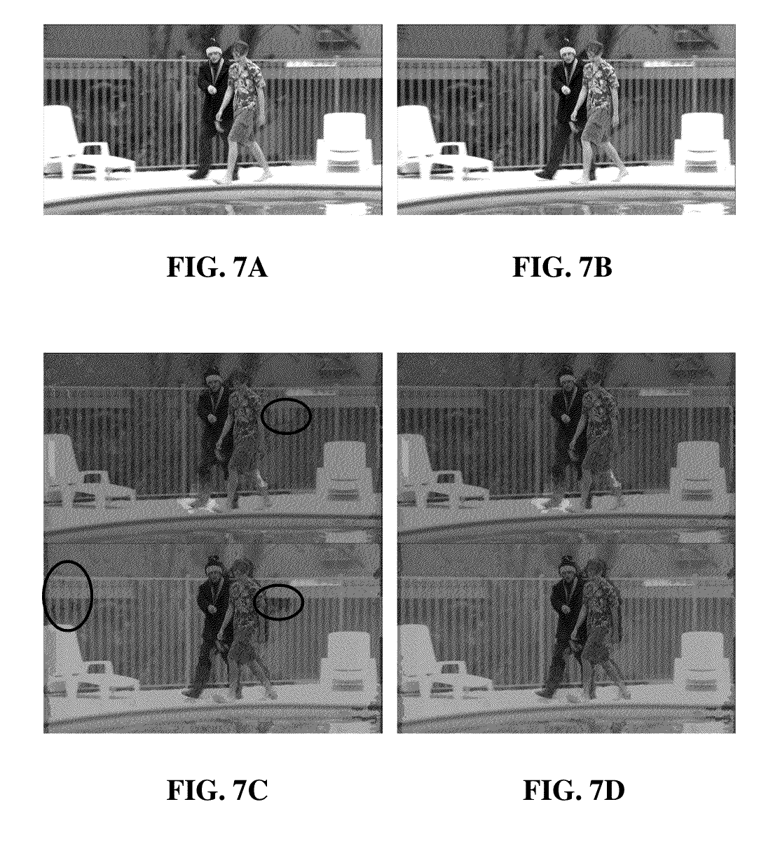

FIGS. 7A to 7D illustrate an exemplary result of displacement vector correction according to an exemplary embodiment, e.g., the displacement vector correction method of FIG. 4. As shown in FIGS. 7A to 7D, a displacement vector correction according to an exemplary embodiment improves handling of periodic patterns, without degrading the motion vector field elsewhere.

In detail, FIGS. 7A and 7B are original subsequent images from a video sequence. Furthermore, FIG. 7C illustrates estimated motion fields. In particular, the upper half of FIG. 7C illustrates the forward motion field, i.e., from FIG. 7A to FIG. 7B, and the lower half of FIG. 7C illustrates the backward motion field, i.e., FIG. 7B to FIG. 7A. Errors due to periodic patterns are encircled with a black line in FIG. 7C. FIG. 7D is the same image as FIG. 7C, after displacement vector correction according to an exemplary embodiment.

In FIGS. 7C and 7D, color represents motion field direction. That is, hue is the motion vector direction and saturation is its magnitude. Thus, red represents a shift to the right and blue represents a shift to the left. The method was applied both to the forward motion field and to the backward motion field, in a completely separate manner. By comparing the images in FIGS. 7C and 7D, it is clear that in both the forward motion field and the backward motion field, the quality of the image is significantly improved by adopting the method according to an exemplary embodiment.

As described above, efficient periodic pattern handling in an image in terms of time and accuracy may be achieved in identifying and correcting displacement vector errors in an image due to periodic patterns by considering relations between displacement vectors of segments of the image in order to identify suspected periodicities in the image which could have resulted in an erroneous displacement vector. In further detail, a relatively small number of possible error-generating periodicities may be identified according to one or more exemplary embodiments. This allows checking specifically if these periodicities exist in the original image, thus avoiding the drawbacks of using Fourier transform. Accordingly, high sensitivity to periodic patterns that have a small number of periods, for example, as low as two to three periods, or of small period length, for example, as low as a few pixels, may be achieved according to one or more exemplary embodiments.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more elements of the above-described apparatus 200 can include circuitry, a processor, a microprocessor, etc., and may execute a computer program stored in a computer-readable medium. For example, it is understood that the elements of the above-described apparatus may be implemented by at least one processor.

It will be understood by those of ordinary skill in the art that various changes in form and detail may be made herein without departing from the spirit and scope of the inventive concept. Therefore, the scope of the inventive concept is defined not by the detailed description of exemplary embodiments but by the appended claims, and all differences within the scope will be construed as being included in the inventive concept.

What is claimed is:

1. An apparatus for correcting an erroneous displacement vector in an image, the apparatus comprising:
an image divider configured to divide an image into a plurality of segments according to displacement vectors of pixels of the image, each of the plurality of segments corresponding to a representative displacement vector;
an erroneous displacement vector detector configured to determine whether a representative displacement vector of a current comparing segment, from among the plurality of segments, is erroneous due to periodicity by comparing the representative displacement vector of the current comparing segment with a representative displacement vector of a reference segment, from among the plurality of segments; and
a displacement vector corrector configured to correct the representative displacement vector of the current comparing segment in response to the erroneous displacement vector detector determining that the representative displacement vector of the current comparing segment is erroneous.

2. The apparatus according to claim 1, wherein the image divider is configured to divide the image into the plurality of segments based on a displacement vector map for the image, the displacement vector map identifying each pixel or group of pixels of the image with a corresponding pixel or group of pixels of a corresponding image shifted by a corresponding displacement vector.

3. The apparatus according to claim 2, wherein the image divider is configured to determine, based on the displacement vector map, connected components of pixels which are within a predetermined distance of each other and have same displacement vector values or displacement vector values that are similar to a predetermined degree, and to merge the determined connected components of pixels to form the plurality of segments.

4. The apparatus according to claim 3, wherein the image divider is configured to determine and merge the connected components of pixels using a flood fill algorithm.

5. The apparatus according to claim 1, wherein the image divider is configured to determine, as a representative displacement vector of a segment from among the plurality of segments, a mean displacement vector of displacement vectors of pixels of the segment.

6. The apparatus according to claim 1, wherein the erroneous displacement vector detector is configured to determine, as the reference segment, a largest segment from among the plurality of segments.

7. The apparatus according to claim 1, wherein the erroneous displacement vector detector is configured to determine, as the reference segment, a largest segment from among the plurality of segments determined to have a common border with the current comparing segment and a different representative displacement vector than the representative displacement vector of the current comparing segment.

8. The apparatus according to claim 1, wherein the erroneous displacement vector detector is configured to compare the representative displacement vector of the current comparing segment with representative displacement vectors of a predetermined number of reference segments, from among the plurality of segments, to determine if the representative displacement vector of the current comparing segment is erroneous due to periodicity.

9. The apparatus according to claim 1, wherein the erroneous displacement vector detector is configured to determine that the representative displacement vector of the current comparing segment is erroneous in response to determining that \vec{u}≡\vec{v}ⱼ−\vec{v}ᵢ is a period of the current comparing segment, where \vec{v}ⱼ is the representative displacement vector of the current comparing segment and \vec{v}ᵢ is the representative displacement vector of the reference segment.

10. The apparatus according to claim 9, wherein the erroneous displacement vector detector is configured to determine that \vec{u}≡\vec{v}ⱼ−\vec{v}ᵢ is the period of the current comparing segment by computing SAD(Cⱼ, \vec{w}) for a group of different vectors \vec{w} which are distributed between a predetermined range of \vec{u}, applying a parabolic approximation using a Savitzky-Golay filter, and comparing a minimum of a corresponding parabola with \vec{u}.

11. The apparatus according to claim 1, wherein, in response to the erroneous displacement vector detector determining that the representative displacement vector of the current comparing segment is erroneous, the displacement vector corrector is configured to replace the representative displacement vector of the current comparing segment with the representative displacement vector of the reference segment or to shift the representative displacement vector of the current comparing segment by the representative displacement vector of the reference segment.

12. A method for correcting an erroneous displacement vector in an image, the method comprising:
dividing an image into a plurality of segments according to displacement vectors of pixels of the image, each of the plurality of segments corresponding to a representative displacement vector;
determining whether a representative displacement vector of a current comparing segment, from among the plurality of segments, is erroneous due to periodicity by comparing the representative displacement vector of the current comparing segment with a representative displacement vector of a reference segment, from among the plurality of segments; and
correcting the representative displacement vector of the current comparing segment in response to determining that the representative displacement vector of the current comparing segment is erroneous.

13. The method according to claim 12, wherein the dividing the image comprises:
determining, based on a displacement vector map, connected components of pixels which are within a predetermined distance of each other and have same displacement vector values or displacement vector values that are similar to a predetermined degree; and
merging the determined connected components of pixels to form the plurality of segments,
wherein the displacement vector map identifies each pixel or group of pixels of the image with a corresponding pixel or group of pixels of a corresponding image shifted by a corresponding displacement vector.

14. The method according to claim 12, wherein the determining whether the representative displacement vector of the current comparing segment is erroneous due to periodicity comprises determining that the representative displacement vector of the current comparing segment is erroneous in response to determining that \vec{u}≡\vec{v}ⱼ−\vec{v}ᵢ is a period of the current comparing segment, where \vec{v}ⱼ is the representative displacement vector of the current comparing segment and \vec{v}ᵢ is the representative displacement vector of the reference segment.

15. The method according to claim 12, wherein the correcting the representative displacement vector of the current comparing segment comprises, in response to determining that the representative displacement vector of the current comparing segment is erroneous, replacing the representative displacement vector of the current comparing segment with the representative displacement vector of the reference segment or shifting the representative displacement vector of the current comparing segment by the representative displacement vector of the reference segment.

16. A non-transitory computer readable recording medium having recorded thereon a program executable by a computer for performing the method of claim 12.

17. A method of detecting an erroneous representative displacement vector from among a plurality of representative displacement vectors respectively corresponding to a plurality of segments, the method comprising:
comparing a representative displacement vector of a current comparing segment, from among the plurality of segments, with a representative displacement vector of a reference segment, from among the plurality of segments; and
determining, based on the comparing, whether the representative displacement vector of the current comparing segment is erroneous due to periodicity,
wherein the comparing and the determining are performed, for the current comparing segment, repeatedly with different reference segments, from among the plurality of segments, until the representative displacement vector of the current comparing segment is determined to be erroneous or until the representative displacement vector of the current comparing segment has been compared to representative displacement vectors of a predetermined number of different segments.

18. The method according to claim 17, wherein the determining comprises determining that the representative displacement vector of the current comparing segment is erroneous in response to determining that \vec{u}≡\vec{v}ⱼ−\vec{v}ᵢ is a period of the current comparing segment, where \vec{v}ⱼ is the representative displacement vector of the current comparing segment and \vec{v}ᵢ is the representative displacement vector of the reference segment.

19. The method according to claim 17, wherein the comparing comprises determining, as the reference segment, a segment determined to have a common border with the current comparing segment and a different representative displacement vector than the representative displacement vector of the current comparing segment.

20. A non-transitory computer readable recording medium having recorded thereon a program executable by a computer for performing the method of claim 17.
